(19) United States
(12) Patent Application Publication
(10) Pub. No.: US 2020/0255049 A1
(43) Pub. Date: Aug. 13, 2020

(54) STEERING DEVICE

(71) Applicant: Isuzu Motore Limited, Tokyo (JP)

(72) Inventors: Junpei OKUTANI, Fujisawa-shi (JP); Haruyuki HOSOYA, Yokohama-shi (JP); Kousuke KAWAKAMI, Yokohama-shi (JP)

(73) Assignee: Isuzu Motore Limited, Tokyo (JP)

(21) Appl. No.: 16/642,920

(22) PCT Filed: Jul. 4, 2018
(86) PCT No.: PCT/JP2018/025367

§ 371 Date: Feb. 28, 2020

(30) Foreign Application Priority Data
Aug. 30, 2017 (JP) 2017-1657766

(51) Int. Cl. B62D 1/18; B62D 1/184; B62D 5/00

(52) U.S. Cl. CPC B62D 1/18; B62D 5/00; B62D 1/184

(57) ABSTRACT

A steering device (1) installed in a vehicle and having: a column bracket (31) secured to the vehicle; a steering bracket (32) for supporting a coaxial motor (20) which applies a rotational force to a steering shaft (4) and is provided in a manner such that the output shaft thereof is coaxial with the steering shaft (4); a connecting member (33) for connecting the steering bracket (32) to the column bracket (31) in a manner such that the steering bracket (32) is capable of movement in the tilt direction, and moves in conjunction with the movement of the steering bracket (32) in the tilt direction; and a suppression member (34) which suppresses the movement of the steering bracket (32) in the tilt direction, and is connected to the connecting member (33) and to the column bracket (31).

### TECHNICAL FIELD

The present disclosure relates to a steering device mounted on a vehicle.

### BACKGROUND ART

Conventionally, it is known that, regarding steering devices to be mounted on a vehicle, some of the steering devices include a motor for applying a rotational force to a steering shaft, and further include a tilting mechanism (see, for example, Patent Literature (hereinafter, referred to as “PTL”) 1).

### CITATION LIST

### Patent Literature

PTL 1 Japanese Patent Application Laid-Open No. 2015-140102

### SUMMARY OF INVENTION

### Technical Problem

However, in the conventional steering devices, for example, when tilt lock is released for tilt adjustment, there is a possibility that a steering wheel suddenly falls to the driver side due to the weight of a motor provided on a steering column.

An object of the present disclosure is to provide a steering device which makes it possible to prevent the steering wheel from falling suddenly.

### Solution to Problem

The steering device according to the present disclosure is a steering device to be mounted on a vehicle, the steering device including: a column bracket to be fixed to the vehicle; a steering bracket that supports a coaxial motor, the coaxial motor including an output shaft arranged coaxially with a steering shaft, the coaxial motor causing rotational power to act on the steering shaft; a coupling member that couples the steering bracket to the column bracket such that the steering bracket is movable in a tilt direction, the coupling member moving in conjunction with a motion of the steering bracket in the tilt direction; and a restraining member that is coupled to the coupling member and the column bracket, the restraining member restraining the motion of the steering bracket in the tilt direction.

### Advantageous Effects of Invention

According to the present disclosure, it is possible to prevent a steering wheel from falling suddenly.

### BRIEF DESCRIPTION OF DRAWINGS

FIG. 1 schematically illustrates a steering device according to an embodiment of the present invention;

FIG. 2 schematically illustrates details of the steering device;

FIG. 3 is an exploded perspective view of a column bracket, a steering bracket, a coupling member, and an elastic member;

FIG. 4 is a top view of the steering bracket (coaxial motor);

FIG. 5 is a side view of the column bracket and the steering bracket;

FIG. 6 is an explanatory view for explaining an exemplary operation of the steering device; and

FIG. 7 is an explanatory view for explaining an exemplary operation of the steering device.

### DESCRIPTION OF EMBODIMENT

Hereinafter, an embodiment of the present disclosure will be described in detail with reference to the accompanying drawings.

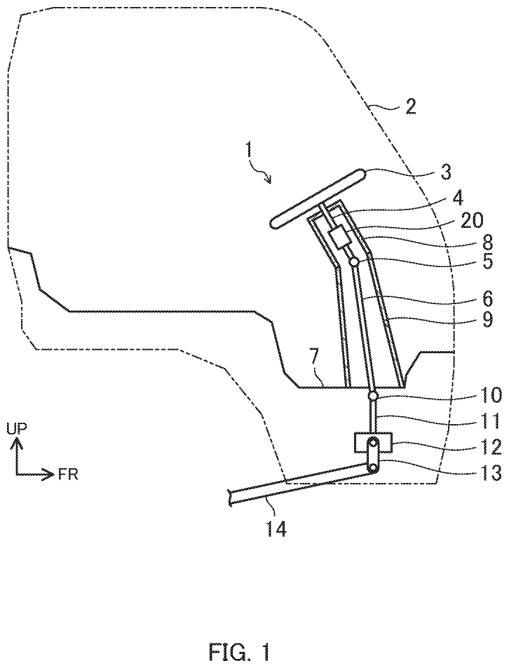

Steering device 1 according to the present embodiment will be described with reference to FIG. 1. FIG. 1 schematically illustrates steering device 1 according to the present embodiment. In FIG. 1, FR indicates the front side of a vehicle, and UP indicates the upper side of the vehicle.

Steering device 1 is mounted on the vehicle provided with vehicle cabin 2. The vehicle is a cab-over type vehicle (for example, a truck, a bus, or the like) provided with vehicle cabin 2 above an internal combustion engine (not illustrated). Steering device 1 is also applicable to a type of vehicle provided with an internal combustion engine in front of or behind vehicle cabin 2.

Steering device 1 includes steering wheel 3, first steering shaft 4, first joint part 5, second steering shaft 6, second joint part 10, third steering shaft 11, power steering unit 12, pitman arm 13, drag link 14, and coaxial motor 20.

Steering wheel 3 is a device with which a driver performs a rotating operation for steering the vehicle.

First steering shaft 4 is a rotatable rod-like member, and is connected at one end to steering wheel 3 and connected at the other end to first joint part 5.

First joint part 5 couples first steering shaft 4 to second steering shaft 6 at a predetermined angle.

First steering shaft 4 is covered peripherally by a cylindrical upper cover (also referred to as a steering cowl) 8. Meanwhile, first joint part 5 is covered peripherally by a cylindrical lower cover (also referred to as a column cover or a column boot) 9. The upper end of lower cover 9 is connected to the lower end of upper cover 8, and the lower end of lower cover 9 is fixed to floor (bottom) 7 of vehicle cabin 2.

Second steering shaft 6 is a rotatable rod-like member, and includes a shaft (not illustrated) and a cylindrical member (not illustrated) surrounding the shaft, which are coupled together so as to be relatively slidable in the axial direction, making second steering shaft 6 extendible and retractable, for example.

Second steering shaft 6 is connected at one end to first joint part 5 and connected at the other end to second joint part 10 disposed below floor 7 (outside vehicle cabin 2). Specifically, the other end of second steering shaft 6 is inserted into an opening (not illustrated) formed in floor 7 and connected to second joint part 10.

Second joint part 10 couples second steering shaft 6 to third steering shaft 11 at a predetermined angle.

A portion of second steering shaft 6 located above floor 7 (portion located in vehicle cabin 2) is covered peripherally by lower cover 9.

Third steering shaft 11 is a rotatable rod-like member, and is connected at one end to second joint part 10 and connected at the other end to power steering unit (also referred to as steering gearbox) 12.

The rotational force of steering wheel 3 is transmitted to power steering unit 12 via first steering shaft 4, second steering shaft 6, and third steering shaft 11.

Power steering unit 12 converts the rotational force transmitted as described above into a larger force that swings pitman arm 13. Thus, pitman arm 13 swings to push or pull drag link 14, so that wheels (not illustrated) are steered via knuckle arms and tie rods (both not illustrated).

Coaxial motor 20 is housed in upper cover 8. An output shaft (not illustrated) of coaxial motor 20 is arranged coaxially with first steering shaft 4. Coaxial motor 20 is driven under the control of an ECU (not illustrated) to apply the rotational force to first steering shaft 4.

For example, when a driving assistance function is executed, the ECU drives coaxial motor 20 such that a predetermined level of rotational force is applied to first steering shaft 4 at a predetermined timing. Examples of the driving assistance function include automatic parking, lane keeping assist during cruise control, and the like.

The rotational force of first steering shaft 4 caused by driving of coaxial motor 20 is transmitted to power steering unit 12 via second steering shaft 6 and third steering shaft 11.

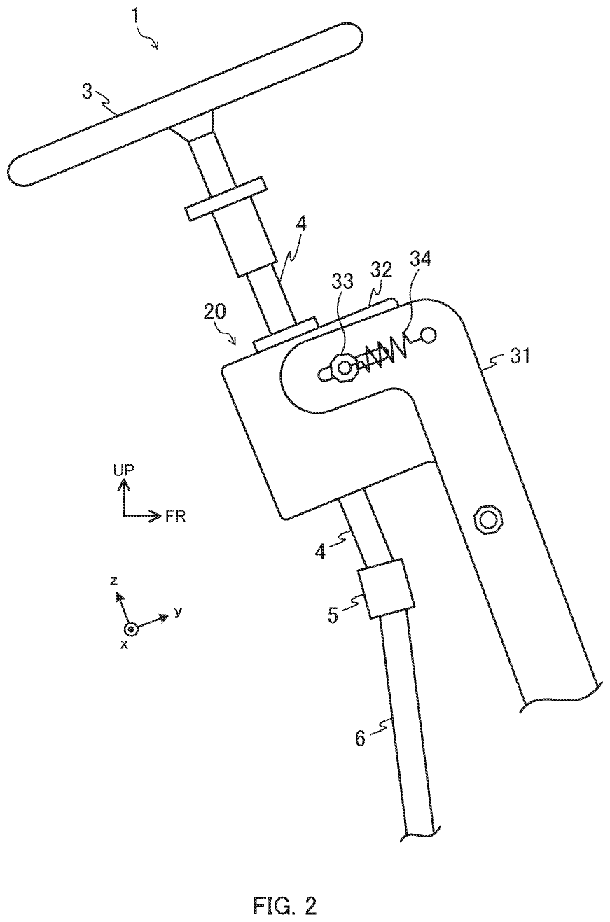

FIG. 2 schematically illustrates details of steering device 1. The same components between FIGS. 1 and 2 are provided with the same reference symbols. In FIG. 2, a coordinate system of three x-, y-, and z-axes is set for steering device 1.

FIG. 2 illustrates column bracket 31, steering bracket 32, coupling member 33, and elastic member 34, which are not illustrated in FIG. 1.

One end of column bracket 31 is fixed to floor 7 of the vehicle (fixed portion is not illustrated).

Steering bracket 32 supports coaxial motor 20. Steering bracket 32 is coupled to column bracket 31 by coupling member 33.

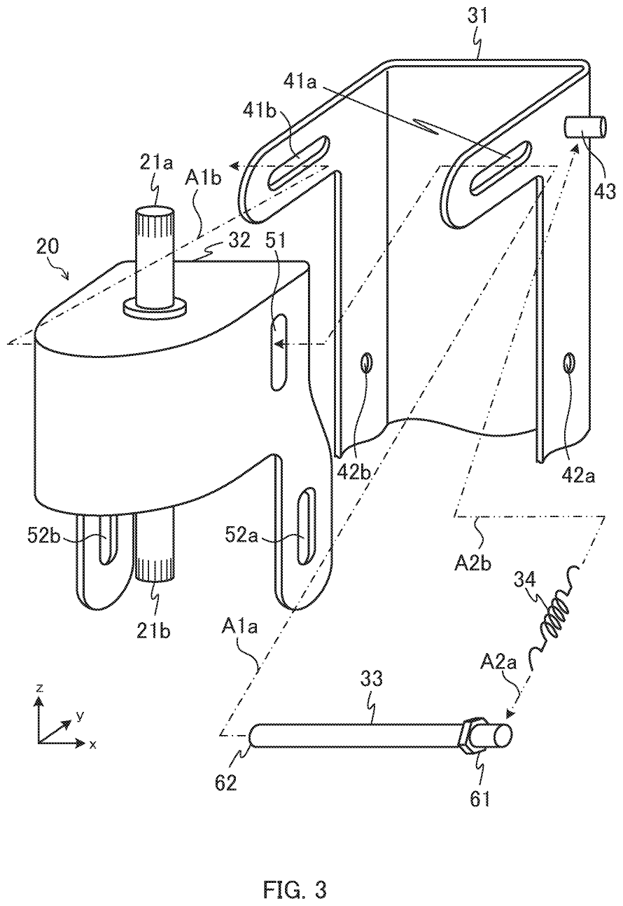

Steering bracket 32 may be part of a housing of coaxial motor 20 (see FIG. 3).

That is, steering bracket 32 may be formed integrally with the housing of coaxial motor 20. Hereinafter, steering bracket 32 will be described as the part of the housing of coaxial motor 20.

Coupling member 33 couples together column bracket 31 and steering bracket 32 such that steering bracket 32 is movable in the tilt direction (the y-axis direction).

Elastic member 34 is, for example, a coil spring, and is connected at one end to coupling member 33 and connected at the other end to column bracket 31.

FIG. 3 is an exploded perspective view of column bracket 31, steering bracket 32, coupling member 33, and elastic member 34. The same components between FIGS. 2 and 3 are provided with the same reference symbols.

As illustrated in FIG. 3, column bracket 31 has holes 41a, 41b, 42a, and 42b and protrusion 43. Steering bracket 32 has holes 51, 52a, and 52b. Coupling member 33 has head portion 61 and tip portion 62.

FIG. 3 also illustrates rotating shafts 21a and 21b of coaxial motor 20. Rotating shafts 21a and 21b of coaxial motor 20 are connected to first steering shaft 4. Rotating shafts 21a and 21b of coaxial motor 20 are coaxial with first steering shaft 4. The rotating shafts (output shafts) of coaxial motor 20 may also serve as first steering shaft 4.

Tip portion 62 of coupling member 33 passes through hole 41a in column bracket 31 and passes through hole 51 in steering bracket 32 as illustrated by dashed dotted line Ala. Tip portion 62 of coupling member 33 passes through hole 41b in column bracket 31 as indicated by dashed dotted line A1b. Head portion 61 of coupling member 33 is of such a size as not to pass through hole 41a in column bracket 31.

Tip portion 62 of coupling member 33 passing through hole 41b in column bracket 31 is coupled to a tilt lever (not illustrated). Steering bracket 32 (coaxial motor 20) is locked or released in terms of its motion in the tilt direction (y-axis direction) according to the operation of the tilt lever.

Note that, another coupling member (not illustrated) different from coupling member 33 also passes through hole 42a in column bracket 31, holes 52a and 52b in steering bracket 32, and hole 42b in column bracket 31. With this configuration, steering bracket 32 is movable also in the telescopic direction (z-axis direction) (description on a telescopic mechanism is omitted).

One end of elastic member 34 is coupled to head portion 61 of coupling member 33 as indicated by two-dot chain line A2a. The other end of elastic member 34 is coupled to protrusion 43 formed on column bracket 31 as indicated by two-dot chain line A2b.

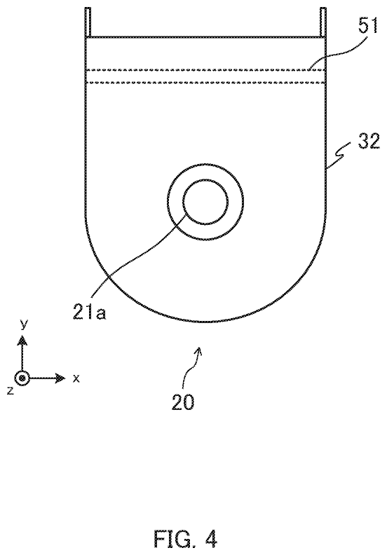

FIG. 4 is a top view of steering bracket 32 (coaxial motor 20). The same components between FIGS. 3 and 4 are provided with the same reference symbols.

The dotted line illustrated in FIG. 4 represents hole 51 in steering bracket 32. Hole 51 extends through steering bracket 32 in the x-axis direction. As described with reference to FIG. 3, tip portion 62 of coupling member 33 passes through hole 51 and hole 41b in column bracket 31, and is coupled to the tilt lever (not illustrated).

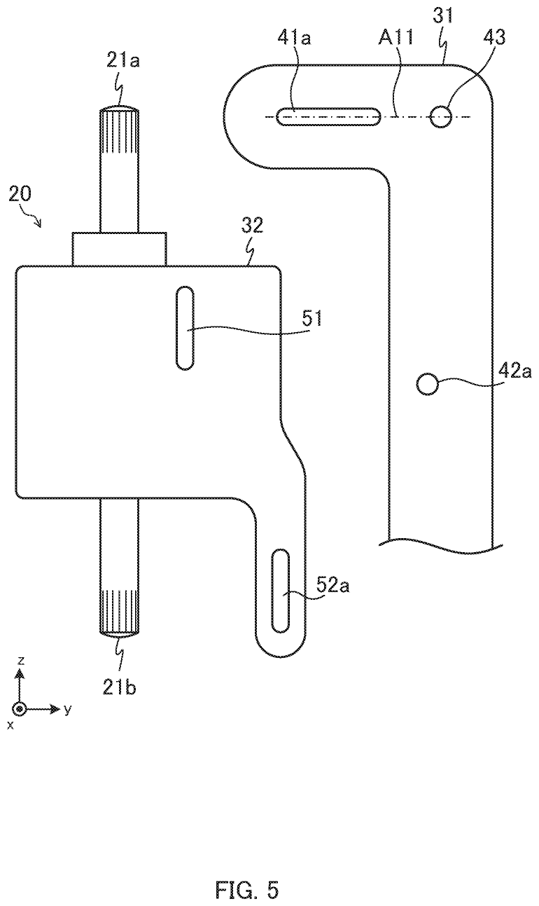

FIG. 5 is a side view of column bracket 31 and steering bracket 32. The same components between FIGS. 3 and 5 are provided with the same reference symbols.

As illustrated in FIG. 5, hole 41a in column bracket 31 is a rectangular hole. Hole 41a is formed to be elongated in the tilt direction (y-axis direction). The short diameter (diameter in the z-axis direction) of hole 41a is slightly larger than the shaft diameter of coupling member 33 such that coupling member 33 is able to move smoothly in the tilt direction. That is, with respect to column bracket 31, coupling member 33 is movable in the tilt direction (y-axis direction) and is not movable in the direction (z-axis direction) perpendicular to the tilt direction. Hole 41b (see FIG. 3) also has the same shape as hole 41a.

Hole 51 in steering bracket 32 is a rectangular hole. Hole 51 is formed to be elongated in the direction (z-axis direction) perpendicular to the tilt direction. The short diameter (diameter in the y-axis direction) of hole 51 is slightly larger than the shaft diameter of coupling member 33 such that steering bracket 32 is able to move smoothly in the telescopic direction (z-axis direction) with respect to coupling member 33. That is, coupling member 33 interlocked with steering bracket 32 is movable in the tilt direction.

Protrusion 43 of column bracket 31 is provided on the extension line of the flow line of coupling member 33 as indicated by one-dot chain line A11 in FIG. 5. Protrusion 43 is formed on the side of hole 41a opposite coaxial motor 20. The other end of elastic member 34 is connected to projection 43.

One end of elastic member 34 is connected to head portion 61 of coupling member 33. Elastic member 34 applies a biasing force so as to bias coupling member 33 in the direction of protrusion 43. For example, when coupling member 33 is a coil spring, a force acts in the direction in which the coil spring contracts.

That is, steering bracket 32 is pulled by elastic member 34 toward column bracket 31 (in the +y-axis direction). That is, a force acts on steering wheel 3 illustrated in FIG. 1 by elastic member 34 toward the FR side. Accordingly, when the driver releases the tilt lock, steering wheel 3 is prevented from suddenly falling to the driver side due to the weight of coaxial motor 20.

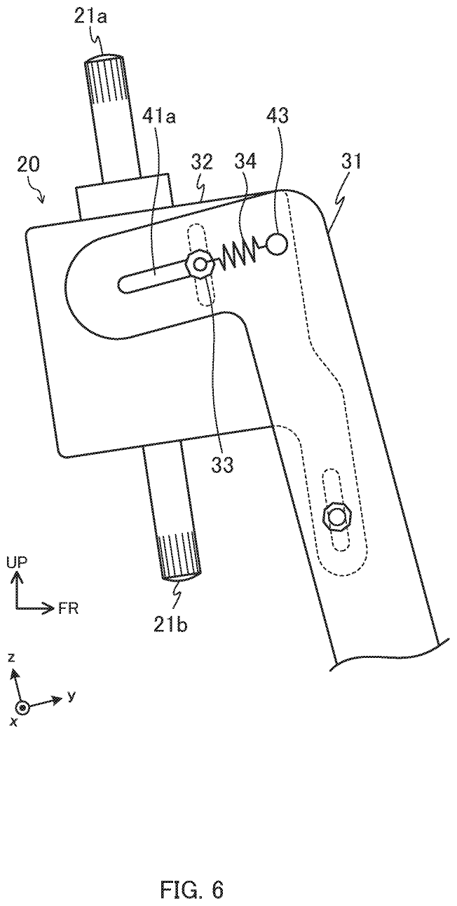

FIG. 6 is an explanatory view for explaining an exemplary operation of steering device 1. The same components between FIG. 6 and FIGS. 2 to 5 are provided with the same reference symbols.

FIG. 6 illustrates the state of steering device 1 where steering wheel 3 is the farthest from the driver. As illustrated in FIG. 6, coupling member 33 is located in part of hole 41a in column bracket 31 which is the closest to protrusion 43.

It is assumed that the driver operates the tilt lever to release the tilt lock in the state of steering device 1 illustrated in FIG. 6. In this case, since steering bracket 32 is coupled to elastic member 34 via coupling member 33, steering bracket 32 is pulled to the FR side by elastic member 34. Accordingly, steering wheel 3 is prevented from suddenly falling to the driver side due to the weight of coaxial motor 20.

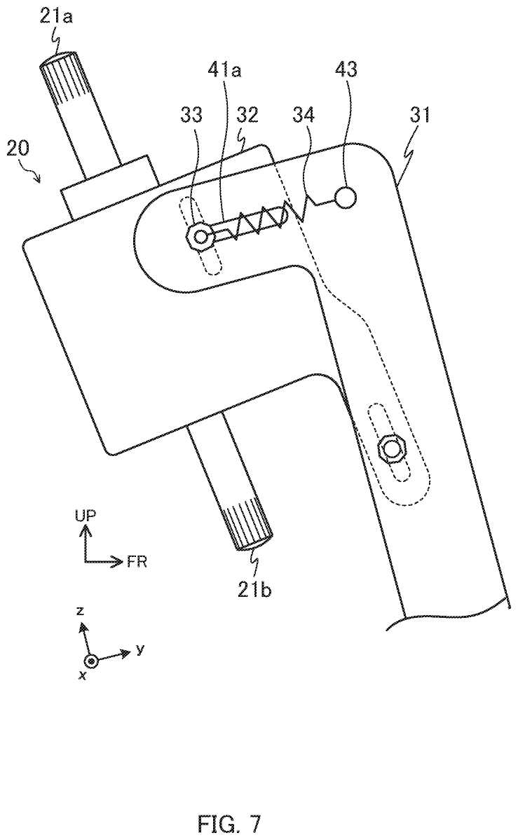

FIG. 7 is an explanatory view for explaining an exemplary operation of steering device 1. The same components between FIG. 7 and FIGS. 2 to 5 are provided with the same reference symbols.

FIG. 7 illustrates the state of steering device 1 where steering wheel 3 is the closest to the driver. As illustrated in FIG. 7, coupling member 33 is located in part of hole 41a in column bracket 31 which is the farthest from protrusion 43.

It is assumed that the driver operates the tilt lever to release the tilt lock in the state of steering device 1 illustrated in FIG. 7. In this case, since steering bracket 32 is coupled to elastic member 34 via coupling member 33, steering bracket 32 is pulled to the FR side by elastic member 34. Accordingly, the driver can easily (with a small force) tilt steering wheel 3 toward the FR side.

As described above, steering device 1 includes column bracket 31 fixed to the vehicle, and steering bracket 32 that supports coaxial motor 20 including the output shaft arranged coaxially with first steering shaft 4 and causing rotational power to act on first steering shaft 4. Further, steering device 1 includes: coupling member 33 that couples steering bracket 32 to column bracket 31 such that steering bracket 32 is movable in the tilt direction, and that moves in conjunction with the motion of steering bracket 32 in the tilt direction; and elastic member 34 that is coupled to coupling member 33 and column bracket 31 and restrains the motion of steering bracket 32 in the tilt direction.

Thus, steering wheel 3 is prevented from suddenly falling to the driver side due to the weight of coaxial motor 20 fixed to steering bracket 32.

Further, it is possible for the driver to tilt steering wheel 3 toward the FR side easily.

Elastic member 34 may also be a damper. Elastic member 34 may also be a damper provided with a coil spring.

Further, elastic member 34 may, for example, have a biasing force that allows steering wheel 3 to move to the FR side when the tilt lock is released. Elastic member 34 may also have a biasing force that allows steering wheel 3 to gradually move to the driver side when the tilt lock is released, for example. Elastic member 34 may also have a biasing force that stops steering wheel 3 when the tilt lock is released, for example.

This application is based on Japanese Patent Application No. 2017-165766, filed on Aug. 30, 2017, the disclosure of which is incorporated herein by reference in its entirety.

### INDUSTRIAL APPLICABILITY

The steering device according to the present disclosure is suitable for preventing a steering wheel of a vehicle from suddenly falling.

### REFERENCE SIGNS LIST

1 Steering device
2 Vehicle cabin
3 Steering wheel
4 First steering shaft
5 First joint part
6 Second steering shaft
7 Floor
8 Upper cover
9 Lower cover
10 Second joint part
11 Third steering shaft
12 Power steering unit
13 Pitman arm
14 Drag link
20 Coaxial motor
31 Column bracket
32 Steering bracket
33 Coupling member
34 Elastic member
41a, 41b, 42a, 42b, 51, 52a, 52b Hole
43 Protrusion
61 Head portion
62 Tip portion

What is claimed is:

1. A steering device to be mounted on a vehicle, the steering device comprising:
a column bracket to be fixed to the vehicle;
a steering bracket that supports a coaxial motor, the coaxial motor including an output shaft arranged coaxially with a steering shaft, the coaxial motor causing rotational power to act on the steering shaft;
a coupling member that couples the steering bracket to the column bracket such that the steering bracket is movable in a tilt direction, the coupling member moving in conjunction with a motion of the steering bracket in the tilt direction; and
a restraining member that is coupled to the coupling member and the column bracket, the restraining member restraining the motion of the steering bracket in the tilt direction.

2. The steering device according to claim 1, wherein
the restraining member applies a biasing force in a direction opposite to a direction in which the steering bracket is moved by a weight of the coaxial motor.

3. The steering device according to claim 1, wherein
the restraining member is a coil spring connected at one end to the coupling member and connected at another end to the column bracket.

4. The steering device according to claim 1, wherein
the restraining member is a damper.

5. The steering device according to claim 1, wherein
the steering bracket is a part of a housing of the coaxial motor.
